(19) United States
(12) Patent Application Publication
(10) Pub. No.: US 2008/0079638 A1
(43) Pub. Date: Apr. 3, 2008

(54) Method for reducing electromagnetic field of terminal and terminal having structure for reducing electromagnetic field

(75) Inventors: Hyung-Do Choi, Seoul (KR); Dong-Ho Kim, Daejon (KR); Dong-Uk Sim, Daejon (KR); Jae-Ick Choi, Daejon (KR); Ae-Kyoung Lee, Daejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: ELECTRONICS AND TELECOMMUNICATIONS RESEARCH INSTITUTE

(21) Appl. No.: 11/645,498

(22) Filed: Dec. 27, 2006

(30) Foreign Application Priority Data
Sep. 29, 2006 (KR) 10-2006-0095790

(51) Int. Cl. H01Q 1/24

(52) U.S. Cl. 343/702

(57) ABSTRACT

A method of reducing electromagnetic field using metamaterial and a terminal having a structure for reducing an electromagnetic field using a metamaterial are provided. The method includes the steps of: deciding a body contacting part of a portable terminal or a wearable terminal; and disposing an electromagnetic field absorption member formed of metamaterial between an antenna and the decided body contacting part.

### FIELD OF THE INVENTION

The present invention relates to a method of reducing electromagnetic field using metamaterial and a terminal having a structure for reducing an electromagnetic field using a metamaterial.

### DESCRIPTION OF RELATED ARTS

Nowadays, various electric and electronic devices are frequency used in daily life. Accordingly, the interest and concern about a relationship between health and electromagnetic field radiated from the electric and electronic devices have increased, and related researches have been in actively progress, internationally. Especially, the concern about the influence of electromagnetic field radiation from a mobile terminal which is used by closely contacting to human body and from a wearable terminal that is expected to be frequently used in ubiquitous society in near future has increased. National or international organizations have defined a reference of specific absorption rate (SAR) for electric and electron devices such as a mobile terminal. United States of America, Japan, Austria, Canada, and Republic of Korea regulate the SAR of electric and electron devices by law. Accordingly, the countermeasures against such regulations are needed urgently. The standardization of a method of measuring a SAR of a wearable terminal has been in progress by IEC TC 106. It is expected to define a reference of measuring the SAR in Republic of Korea in near future. The SAR is an absorption power of unit mass, which is absorbed into a human body if the human body is exposed to the electromagnetic field.

$$SAR = \frac{1}{2} \frac{σ}{ρ} {\vert {E}_{i} \vert}^{2} \qquad Eq . 1$$

Herein, σ denotes the electric conductivity of human phantom, ρ denotes a density, and |Eᵢ| denotes a size of a peak value of a local field vector. The SAR in living body is in proportional to the square of electric field intensity. Such a SAR is decided by a frequency which is a parametric variable of incident electromagnetic field, an intensity of electromagnetic field, a direction of electromagnetic field, a source of electromagnetic field, a relative location of target object, genetic characteristics of exposed human body part, influence of ground, and an exposed environment.

In order to reduce the influence of electromagnetic field, an electromagnetic field blocking case for a wireless communication terminal was introduced. Various types and shapes of cases were manufactured using conductors to block the electromagnetic field radiated from the terminal. Although such a case can block the EMI or EMS of bands except a carrier frequency, it cannot fundamentally reduce the influence of the electromagnetic field radiated from the antenna. If an electromagnetic field blocking material is used in a portable terminal, the SAR may increase because the electromagnetic field blocking material may reflect the electromagnetic field directly to human body. As another conventional technology, a method of reducing an SAR by disposing an antenna at a lower part of a terminal in order to separate the antenna away from the head was introduced. Although such an arrangement of the antenna can advantageously reduce the SAR to the head, it may seriously influence the heart. Also, since the antenna is disposed at the lower part of the terminal, a user's hand may block the antenna, thereby degrading the radiation performance. Furthermore, as another conventional technology, a method of reducing SAR by applying an electromagnetic field absorption material to an antenna was introduced. This conventional method degrades the performance of a terminal by reducing outputs closely related to speech sensitivity. These materials for blocking or absorbing the electromagnetic field give different results according to the characteristics thereof. The electromagnetic field blocking material may increase the SAR as described above. The electromagnetic field absorbing material decrease about 10 to 20% of the electromagnetic field. However, it is not fundamental countermeasure for eliminating the electromagnetic field. Currently, the electromagnetic field is measured within about 2.5 cm from a device in general, and a proper distance to use a corresponding device according to the measurement result is clearly informed to users. However, most of all electric and electron devices generate electromagnetic field greater than the reference of SAR if a user uses the devices by closely contacting it to a body part, for example, closer than 2.5 cm.

Therefore, there is a demand for a method of reducing electromagnetic field radiated from electric and electronic devices such as a portable terminal in order to reduce the bad influence of the electromagnetic field to human body.

### SUMMARY OF THE INVENTION

It is, therefore, an object of the present invention to provide a terminal having a structure for reducing a specific absorption rate using metamaterial and a method of reducing electromagnetic field using metamaterial.

It is another object of the present invention to provide a terminal having a structure satisfying a specific absorption rate defined at each nation.

In accordance with an aspect of the present invention, there is provided a method for reducing electromagnetic field of a terminal using metamaterial including the steps of: deciding a body contacting part of a portable terminal or a wearable terminal; and disposing an electromagnetic field absorption member formed of metamaterial between an antenna and the decided body contacting part.

In accordance with an aspect of the present invention, there is also provided a terminal using a metamaterial including: an electromagnetic field reduction member formed of metamaterial; and an antenna disposed an opposite side of a body contacting part of a portable terminal or a wearable terminal from the electromagnetic field reduction member.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram illustrating a terminal in accordance with an embodiment of the present invention;

FIG. 2 is a diagram illustrating an antenna unit in accordance with an embodiment of the present invention;

FIG. 3 is a diagram illustrating an antenna radiation pattern of a terminal in accordance with an embodiment of the present invention;

FIGS. 4A to 4F are diagrams illustrating various unit cell structures and specifications of metamaterial in accordance with an embodiment of the present invention; and

FIG. 5 is a diagram illustrating a wearable terminal having an electromagnetic field reduction member formed of metamaterial in accordance with an embodiment of the present invention.

### DETAILED DESCRIPTION OF THE INVENTION

Hereinafter, a method of reducing electromagnetic field using metamaterial and a terminal having a structure for reducing an electromagnetic field using a metamaterial will be described in more detail with reference to the accompanying drawings.

The present invention can be applied to a wireless device and a wearable device. The wireless device is generally used by closely contacting it to a predetermined body part. The wireless device includes a wireless communication terminal employing code division multiple access (CDMA), frequency division multiple access (FDMA), or time division multiple access (TDMA). The wearable device includes a wearable computer and a wearable terminal. The object of the present invention is to provide a terminal having a structure that reduces an electromagnetic field using metamaterial by forming a radiation pattern in a half moon shape or a fan shape that reduce electromagnetic field radiation in a direction to a user's body.

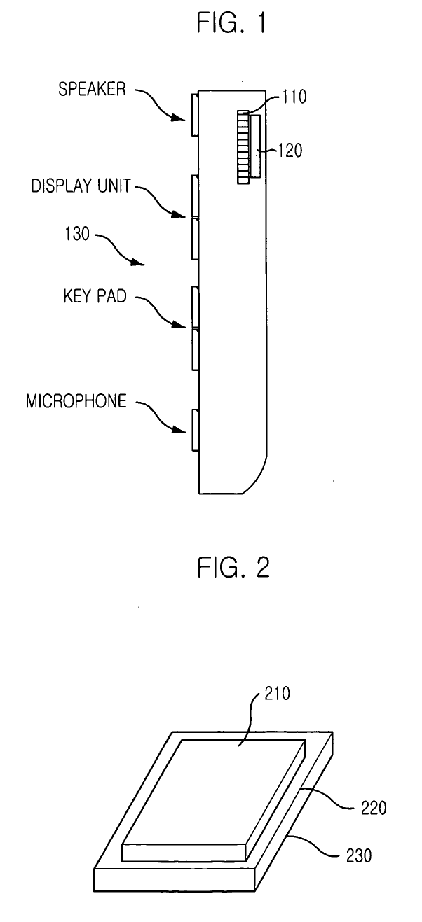

FIG. 1 is a diagram illustrating a terminal in accordance with an embodiment of the present invention.

Referring to FIG. 1, the terminal according to the present embodiment includes an electromagnetic field reduction member 110 formed of metamaterial, and an antenna 120 disposed at an opposite side of the terminal from a body contacting part 130 of the terminal based on the electromagnetic field reduction member 110. The terminal includes a wearable personal computer (PC), a wireless communication terminal, a personal digital assistant (PDA), a digital multimedia broadcasting (DMB) terminal, and wearable devices such as a wrist watch, a headphone, or glasses.

FIG. 2 is a diagram illustrating an antenna unit in accordance with an embodiment of the present invention.

Referring to FIG. 2, the antenna unit includes an antenna 210, an electromagnetic field reduction member 220 formed of metamaterial, and a ground side 230. The metamaterial include an artificial magnetic conductor.

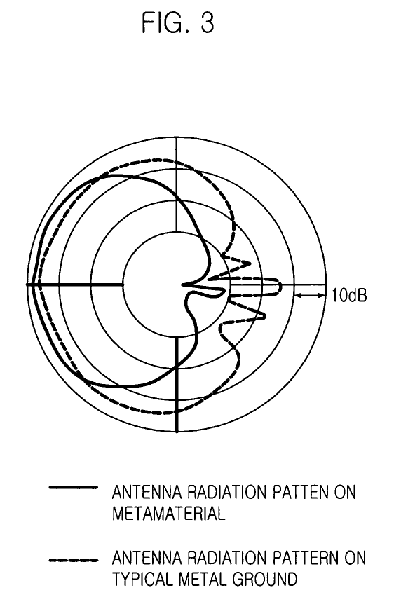

FIG. 3 is a diagram illustrating an antenna radiation pattern of a terminal in accordance with an embodiment of the present invention.

Referring to FIG. 3, the antenna according to the present embodiment forms the antennal radiation pattern in a half moon shape or a fan shape. Therefore, a specific absorption rate (SAR) can be reduced by reducing one direction of the radiation pattern.

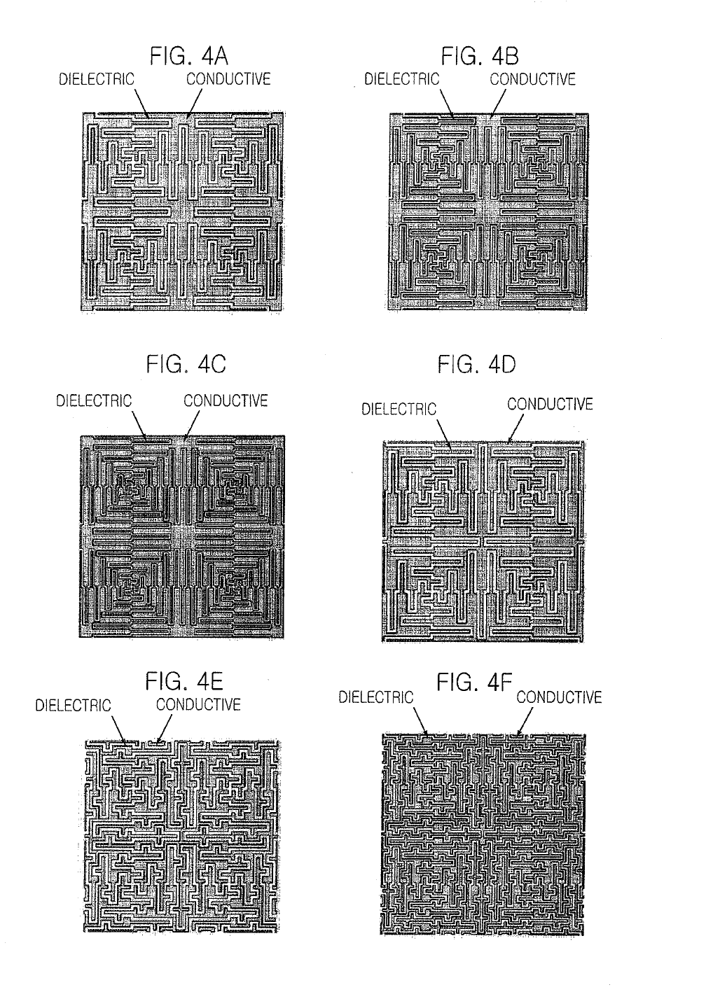

FIGS. 4A to 4F are diagrams illustrating various unit cell structures and specifications of metamaterial in accordance with an embodiment of the present invention.

As shown in unit cell structures of FIGS. 4A to 4F, the electromagnetic field reduction member is formed by forming a dielectric pattern on a conductive substrate, and disposing unit cells in a predetermined formation, where each of the unit cell includes conductors mashed with each other at a predetermined distance separated. In case of using the metamaterial, high impedance is induced on the surface of the metamaterial, and the induced high impedance prevents antenna efficiency and gain from being degraded, which were degraded if an antenna is directly attached on a conductive according to the related art.

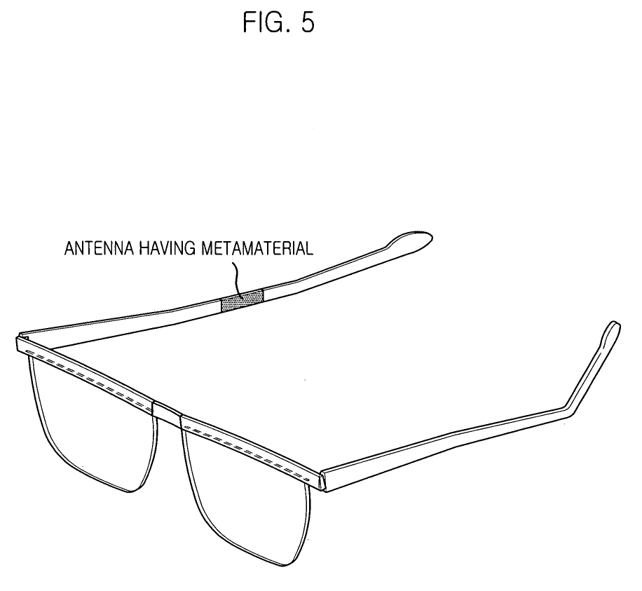

FIG. 5 is a diagram illustrating a wearable terminal having an electromagnetic field reduction member formed of metamaterial in accordance with an embodiment of the present invention.

As shown in FIG. 5, the specific absorption rate (SAR) of the electromagnetic field can be reduced by disposing metamaterial at an inside surface of a glass frame or a headphone. Also, the present invention can be applied by deciding a position of the metamaterial according to a method of wearing various shapes of terminals such as a wrist watch, a reckless, and so on, and attaching the antenna unit at the inside surface of the decided position that is a body contacting part of a corresponding device.

As described above, the terminal according to the present invention includes a structure that can reduces the amount of electromagnetic field by applying metamaterial to an antenna to form an antenna radiation pattern in a half moon shape or a fan shape. The conventional method of reducing specific absorption rate using an absorbing member degrades the speech quality of the terminal. However, the terminal and method for reducing the electromagnetic field according to the present invention reduces the specific absorption rate while improving the performance of the terminal in the opposite direction from a body, thereby minimizing the performance degradation of the terminal.

Also, the problems of antenna efficiency degradation and gain degradation caused by directly attaching an antenna on a conductor can be eliminated by using metamaterial such as high impedance surface according to the present invention.

The present application contains subject matter related to Korean patent application No. 2006-0095790, filed with the Korean patent office on Sep. 29, 2006, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

1. A method for reducing electromagnetic field of a portable or wearable terminal using metamaterial, the method comprising the steps of:
deciding a body contacting part of the portable or a wearable terminal;
disposing an electromagnetic field reduction member formed of metamaterial
between an antenna and the decided body contacting part; and
reducing the electromagnetic field by adjusting a radiation pattern of the antenna.

2. The method as recited in claim 1, wherein the electromagnetic field reduction member includes a plurality of unit cells facing one another with a predetermined spacing there between, and wherein each of the unit cell includes a conductive pattern formed on a dielectric substrate.

3. A portable or wearable terminal using a metamaterial, the portable or wearable terminal comprising:
an electromagnetic field reduction element formed of metamaterial; and
an antenna disposed on an opposite side of a body contacting part of the portable or wearable terminal from the electromagnetic field reduction element,
wherein the electromagnetic field is reduced by adjusting a radiation pattern of the antenna.

4. The portable or wearable terminal as recited in claim 3, wherein the electromagnetic field reduction element includes a plurality of unit cells facing one another with a predetermined spacing there between, and wherein each of the unit cells includes a conductive pattern formed on a dielectric substrate.

5. The method as recited in claim 1, wherein the radiation pattern of the antenna is of a half moon shape or a fan shape.

6. The method as recited in claim 1, wherein the electromagnetic field is reduced toward the body contacting part.

7. The portable or wearable terminal as recited in claim 3, wherein the radiation pattern of the antenna is of a half moon shape or a fan shape.

8. The portable or wearable terminal as recited in claim 3, wherein the electromagnetic field is reduced toward the body contacting part.
